(19) United States
(12) Patent Application Publication
(10) Pub. No.: US 2016/0378491 A1
(43) Pub. Date: Dec. 29, 2016

(54) DETERMINATION OF TARGET LOCATION FOR TRANSFER OF PROCESSOR CONTROL

(71) Applicant: Microsoft Technology Licensing, LLC, Redmond, WA (US)

(72) Inventors: Douglas C. Burger, Bellevue, WA (US); Aaron L. Smith, Seattle, WA (US); Jan S. Gray, Bellevue, WA (US)

(73) Assignee: MICROSOFT TECHNOLOGY LICENSING, LLC, Redmond, WA (US)

(21) Appl. No.: 14/752,660

(22) Filed: Jun. 26, 2015

(51) Int. Cl. G06F 9/38; G06F 9/30

(52) U.S. Cl. CPC G06F 9/3802; G06F 9/3005

(57) ABSTRACT

Methods and apparatus are disclosed for eliminating explicit control flow instructions (for example, branch instructions) from atomic instruction blocks according to a block-based instructions set architecture (ISA). In one example of the disclosed technology, an explicit data graph execution (EDGE) ISA processor is configured to fetch instruction blocks from a memory and execute at least one of the instruction blocks, each of the instruction blocks being encoded to have one or more exit points determining a target location of a next instruction block. Processor control circuitry evaluates one or more predicates for instructions encoded within a first one of the instruction blocks, and based on the evaluating, transfers control of the processor to a second instruction block at a target location that is not specified by a control flow instruction in the first instruction block.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for encoding and executing instruction blocks in block-based processor instruction set architectures (BBISA's), including determination of a target location for transfer of processor control. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, a block-based processor includes a plurality of block-based processor cores.

The described techniques and tools for solutions for improving processor performance can be implemented separately, or in various combinations with each other. As will be described more fully below, the described techniques and tools can be implemented in a signal processor, microprocessor, application-specific integrated circuit (ASIC), a microprocessor implemented in a field programmable gate array (FPGA), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, PDAs, touch screen tablet devices, tablet computers, wearable computers, and laptop computers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and instruction blocks, as can be used in some examples of the disclosed technology.

FIG. 5 illustrates block-based processor headers and instructions, as can be used in some examples of the disclosed technology.

FIG. 6 depicts an example of source code, as can be used in certain examples of the disclosed technology.

FIG. 7 is a diagram of predicate directed acyclical graphs, as can be used in certain examples of the disclosed technology.

FIGS. 8-10 illustrate example machine code, as can be used in certain examples of the disclosed technology.

FIG. 11 is a flowchart illustrating an example method of executing an implicit control flow instruction, as can be practiced in some examples of the disclosed technology.

FIG. 12 is a flowchart illustrating an example of executing an implicit branch instruction, as can be used in certain examples of the disclosed technology.

FIG. 13 is a flowchart illustrating an example method of compiling code including implicit control flow instructions, as can be practiced in certain examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as an agent executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive circuits, such as deep, many-ported register files, many-ported content-accessible memories (CAMs) for dataflow instruction scheduling wakeup, and many-wide bus multiplexers and bypass networks, all of which are resource intensive. For example, in FPGA-based implementations, multi-read, multi-write RAMs may require a mix of replication, multi-cycle operation, clock doubling, bank interleaving, live-value tables, and other expensive techniques.

The disclosed technologies can realize performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor uses an EDGE ISA designed for area- and energy-efficient, high-ILP execution. In some examples, use of EDGE architectures and associated compilers finesses away much of the register renaming, CAMs, and complexity.

In certain examples of the disclosed technology, an explicit data graph execution instruction set architecture (EDGE ISA) includes information about program control flow that can be used to effectively encode control flow instructions within instruction blocks, thereby increasing performance, saving memory resources, and/or and saving energy. In certain examples of the disclosed technology, an EDGE ISA can eliminate the need for one or more complex architectural features, including register renaming, dataflow analysis, mis-speculation recovery, and in-order retirement while supporting mainstream programming languages such as C and C++. Functional resources within the block-based processor cores can be allocated to different instruction blocks based on a performance metric which can be determined dynamically or statically.

Apparatus and methods are disclosed for encoding control flow instructions in block-based instruction set architecture processors. Atomic instruction blocks including two or more instructions do not rely on incrementing or decrementing a program counter in order to determine the next instruction. In some examples of the disclosed technology, instruction blocks are encoded to designate one or more exit points that determine a target location of a next instruction block to execute after the current instruction block is executed. The exit points are determined by values calculated for predicate(s) of the currently-executing instruction block. Control logic circuitry transfers control of the processor from a currently executing instruction block to a next instruction block at a target location that is determined by one of the exit points. The control flow instructions are not limited to branch instructions but include jump instructions, call instructions, return instructions, and other suitable instructions for changing control flow in a block based processor. Each thread of block-based instructions being executed by a block-based processor is associated with a program counter (PC) that indicates the memory location of the currently-executing instruction block.

Accordingly, certain examples of the disclosed technology can include improvements in code size, reduced latency in initiating execution of a next instruction block, and avoidance of branch prediction and/or speculative execution, depending on the particular implementation, by encoding at least one of the exit points for a particular instruction block in an implicit fashion and in some examples, using information encoded within an instruction block header.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic circuitry from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register file.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

As will be readily understood to one of ordinary skill in the relevant art, a spectrum of implementations of the disclosed technology are possible with various area and performance tradeoffs.

### III. Example Block-Based Processor

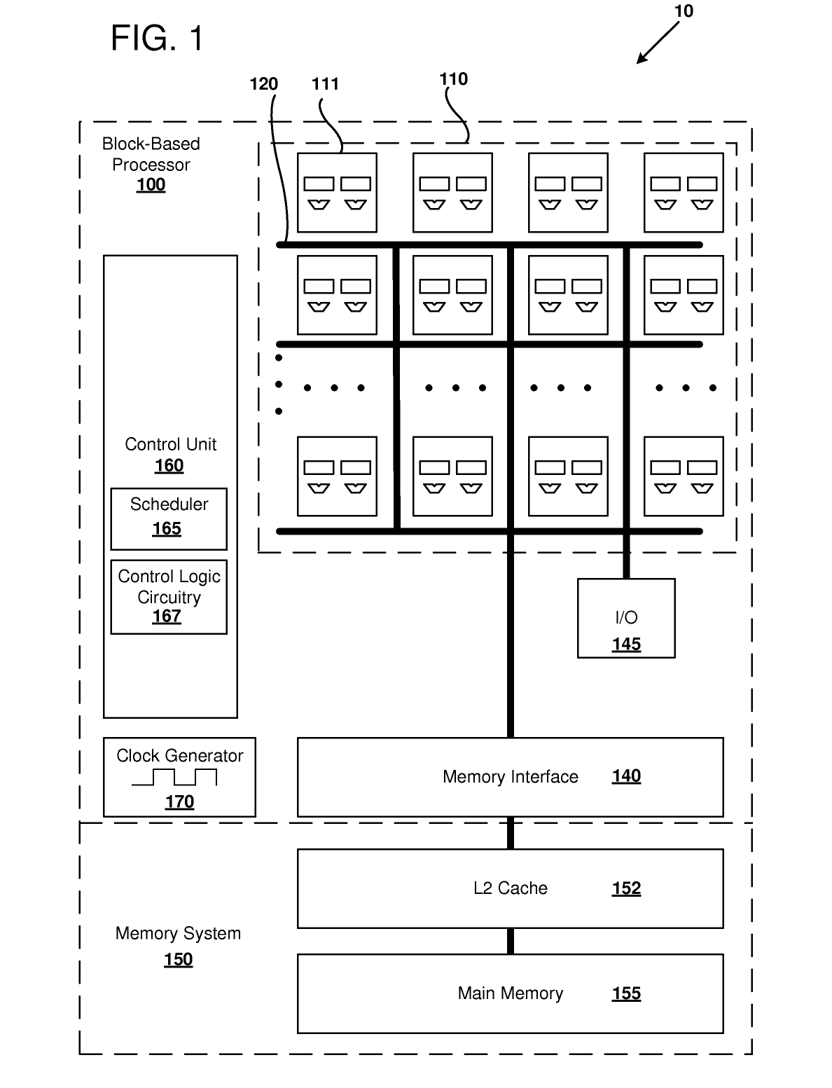

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality 110 of processing cores, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, point-to-point bus links, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit signals that indicate the execution status of instructions currently being executed by each of the respective cores. In some examples, the core interconnect 120 is implemented as wires connecting the cores 110, register file(s), and memory system, while in other examples, the core interconnect can include circuitry for multiplexing data signals on the interconnect wire(s), switch and/or routing components, including active signal drivers and repeaters, pipeline registers, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, neural network coprocessor, machine learned model evaluator coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, the register file(s), the memory interface 140, and/or the I/O interface 145. The control unit 160 can also process hardware interrupts, and control reading and writing of special system registers, for example the program counter stored in one or more register files. In some examples of the disclosed technology, the control unit 160 is at least partially implemented using one or more of the processing cores 110, while in other examples, the control unit 160 is implemented using a non-block-based processing core (e.g., a general-purpose RISC processing core). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 that is used to allocate instruction blocks to the processor cores 110. As used herein, scheduler allocation refers to directing operation of an instruction blocks, including initiating instruction block mapping, fetching, decoding, execution, committing, aborting, idling, and refreshing an instruction block. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The scheduler 165 can be used manage cooperation and/or competition for resources between multiple software threads, including multiple software threads from different processes, that are scheduled to different cores of the same processor. In some examples, multiple threads contend for core resources and the scheduler handles allocation of resources between threads.

The control unit 160 also includes control logic circuitry 167 that can be configured to, for example, transfer control of the processor from the current instruction block to a next instruction block at a target location determined by one of the current instruction block's exit points. In some examples, the control logic circuitry 167 is configured to transfer control of the processor to the determined target location in response to performance of operations including evaluating predicates for encoded instructions for a first instruction block and transfer processor control to a second instruction block at the determined target location.

In some examples, the control unit 160, the scheduler 165, and/or the control logic circuitry 167 are implemented as a finite state machine coupled to the memory. In some examples, an operating system executing on a processor (e.g., a general-purpose processor or a block-based processor core) generates priorities, predictions, and other data that can be used at least in part to perform functions of the control unit 160, the scheduler 165, and/or the control logic circuitry 167. As will be readily apparent to one of ordinary skill in the relevant art, other circuit structures, implemented in an integrated circuit, programmable logic, or other suitable logic can be used to implement hardware for the control unit 160, the scheduler 165, and/or the control logic circuitry 167.

In some examples, all threads execute on the processor 100 with the same level of priority. In other examples, the processor can be configured (e.g., by an operating system or parallel runtime executing on the processor) to instruct hardware executing threads to consume more or fewer resources, depending on an assigned priority. In some examples, the scheduler weighs performance metrics for blocks of a particular thread, including the relative priority of the executing threads to other threads, in order to determine allocation of processor resources to each respective thread.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

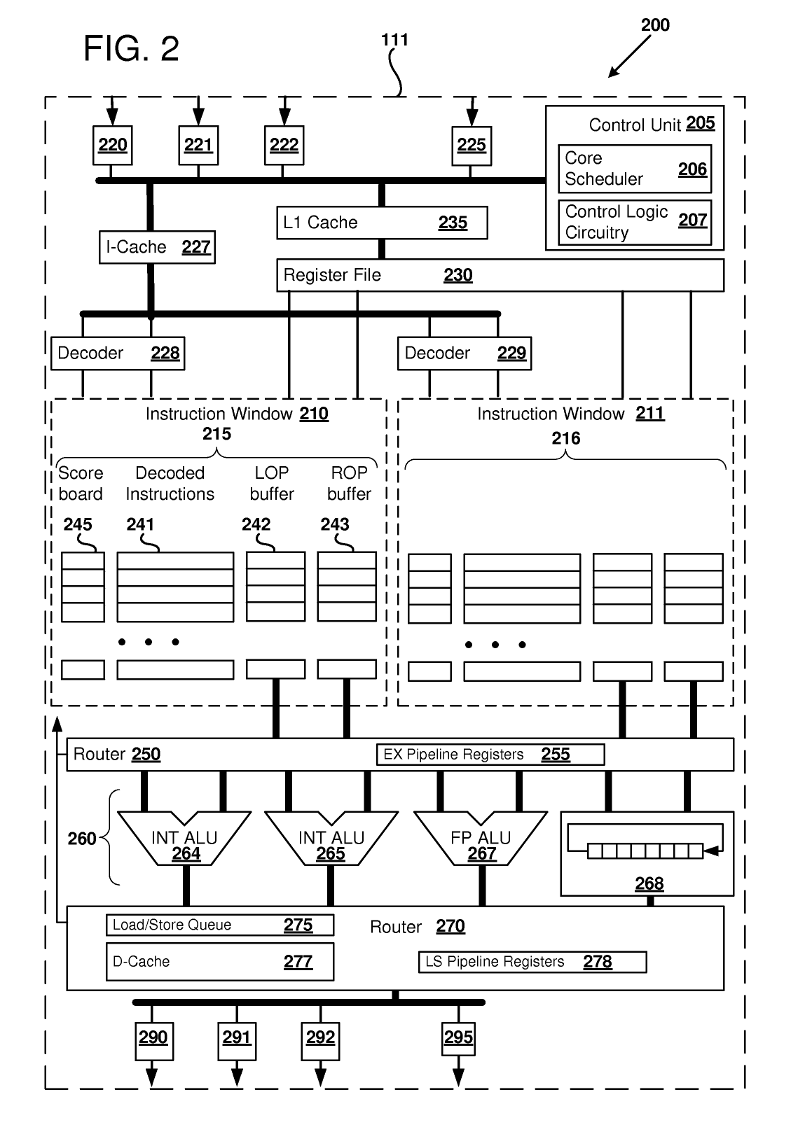

FIG. 2 is a block diagram 200 further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DC), operand fetch, execute (EX), and memory/data access (LS). In some examples, for certain instructions, such as floating point operations, various pipelined functional units of various latencies may incur additional pipeline stages. However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which generates control signals to regulate core operation and to schedule and transfer the flow of instructions using an instruction scheduler 206 and control logic circuitry 207. The processor core instruction scheduler 206 can be used to supplement, or instead of, the processor-level instruction scheduler 165. The instruction scheduler 206 can be used to control operation of instructions blocks within the processor core 111 according to similar techniques as those described above regarding the processor-level instruction scheduler 165.

The control logic circuitry 207 can be used to supplement, or instead of, the control logic circuitry 167. The control logic circuitry 207 can be used to control operation of instructions blocks within the processor core 111 according to similar techniques as those described above regarding the control logic circuitry 167.

In some examples, the control unit 205, the instruction scheduler 206, and/or the control logic circuitry 207 are implemented as a finite state machine coupled to the memory. In some examples, an operating system executing on a processor (e.g., a general-purpose processor or a block-based processor core) generates priorities, predictions, and other data that can be used at least in part to perform functions of the control unit 205, the instruction scheduler 206, and/or the control logic circuitry 207. As will be readily apparent to one of ordinary skill in the relevant art, other circuit structures, implemented in an integrated circuit, programmable logic, or other suitable logic can be used to implement hardware for the control unit 205, the instruction scheduler 206, and/or the control logic circuitry 207.

The exemplary processor core 111 includes two instructions windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early and/or late fetching of instructions and/or data, improved branch prediction, speculative execution, improved energy efficiency, and improved code compactness. In other examples, different numbers of instructions windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction block headers and/or instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associate with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. In the illustrated example, instruction operands are read from the operand buffers 242 and 243, not the register file. In other examples, the instruction operands can be read from the register file 230.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constrained and as directed by the control unit 205.

In some examples of the disclosed technology, front-end pipeline stages IF and DC can run decoupled from the back-end pipelines stages (IS, EX, LS). The control unit can fetch and decode two instructions per clock cycle into each of the instruction windows 210 and 211. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic circuitry 205 then initiates execution of one or more next instruction(s) (e.g., the lowest numbered ready instruction) each cycle and its decoded instruction and input operands are send to one or more of functional units 260 for execution. The decoded instruction can also encodes a number of ready events. The scheduler in the control logic circuitry 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, availability of pipelined function unit issue resources, availability of result write-back resources, or other prerequisites required before executing the associated individual instruction.

In one embodiment, the scoreboard 245 can include decoded ready state, which is initialized by the instruction decoder 231, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can cleared on a block reset or a block refresh. Upon branching to a new instruction block, the decoded ready state, and the decoded active state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 250 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 200 until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), to the register file 230, and/or fed back to another functional unit, depending on the requirements of the particular instruction being executed. The second router 270 includes a load/store queue 275, which can be used to buffer memory instructions, a data cache 277, which stores data being input to or output from the core to memory, and load/store pipeline register 278. The router 270 and load/store queue 275 can thus be used to avoid hazards be ensuring: the atomic, all-or-nothing commitment (write to memory) of any stores; stores which may have issued from the core out of order are ultimately written to memory as-if processed in order; and loads which may have issued from the core out of order return data, for each load, reflecting the stores which logically precede the load, and not reflecting the stores which logically follow the load, even if such a store executed earlier, out of order.

The core also includes control outputs 295 which are used to indicate, for example, when execution of all of the instructions for one or more of the instruction windows 215 or 216 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core 200 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic circuitry 205 of the processor cores 110. The area, clock period, capabilities, and limitations substantially determine the realized performance of the individual cores 110 and the throughput of the block-based processor 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction or instructions to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some cases, the scheduler 206 accepts events for target instructions that have not yet been decoded and must also inhibit reissue of issued ready instructions. In some examples, instructions can be non-predicated or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a mis-speculated issued instruction and the specific transitive closure of instructions in the block that consume its outputs may be re-executed, or mis-speculated side effects annulled. In some examples, discovery of a mis-speculated instruction leads to the complete roll back and re-execution of an entire block of instructions.

Upon branching to a new instruction block that is not already resident in (decoded into) a block's instruction window, the respective instruction window(s) ready state is cleared (a block reset). However when an instruction block branches back to itself (a block refresh), only active ready state is cleared. The decoded ready state for the instruction block can thus be preserved so that it is not necessary to re-fetch and decode the block's instructions. Hence, block refresh can be used to save time and energy in loops.

### V. Example Stream of Instruction Blocks

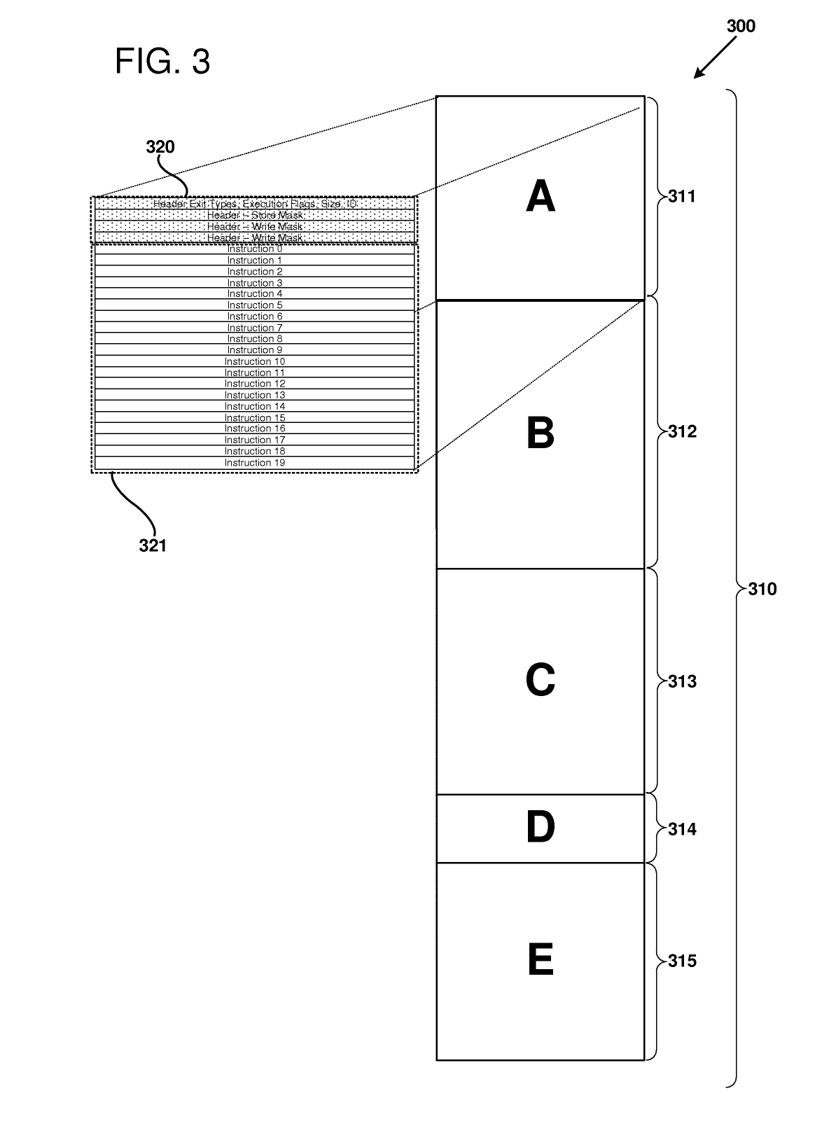

Turning now to the diagram 300 of FIG. 3, a portion 310 of a stream of block-based instructions, including a number of variable length instruction blocks 311-314, is illustrated. The stream of instructions can be used to implement user application, system services, or any other suitable use. In the example shown in FIG. 3, each instruction block begins with an instruction header, which is followed by a varying number of instructions. For example, the instruction block 311 includes a header 320, eighteen instructions 321, and two words of performance metric data 322. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is divided by 4 (e.g., shifted right two bits) in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s).

The block instruction header 320 can also include a number of block exit types for use by, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask, which identifies the load-store queue identifiers that are assigned to store operations. The instruction block header can also include a write mask, which identifies which global register(s) the associated instruction block will write. The associated register file must receive a write to each entry before the instruction block can complete. In the event some predicated execution instruction sequence corresponds to a flow graph path that does not write a particular register, or perform a particular store, a NULL instruction may be used to designate register write(s) and memory store(s) that are not required on that path. In some examples, a block-based processor architecture can include not only scalar instructions, but also single-instruction multiple-data (SIMD) instructions, that allow for operations with a larger number of data operands within a single instruction.

In some examples, performance metric data 321 includes information that can be used to calculate confidence values that in turn can be used to allocate an associated instruction block to functional resources of one or more processor cores. For example, the performance metric data 322 can include indications of branch instructions in the instruction block that are more likely to execute, based on dynamic and/or static analysis of the operation of the associated instruction block 311. For example, a branch instruction associated with a for loop that is executed for a large immediate value of iterations can be specified as having a high likelihood of being taken. Branch instructions with low probabilities can also be specified in the performance metric data 322. Performance metric data encoded in the instruction block can also be generated using performance counters to gather statistics on actual execution of the instruction block.

The instruction block header 320 can also include similar information as the performance metric data 321 described above, but adapted to be included within the header.

### VI. Example Block Instruction Target Encoding

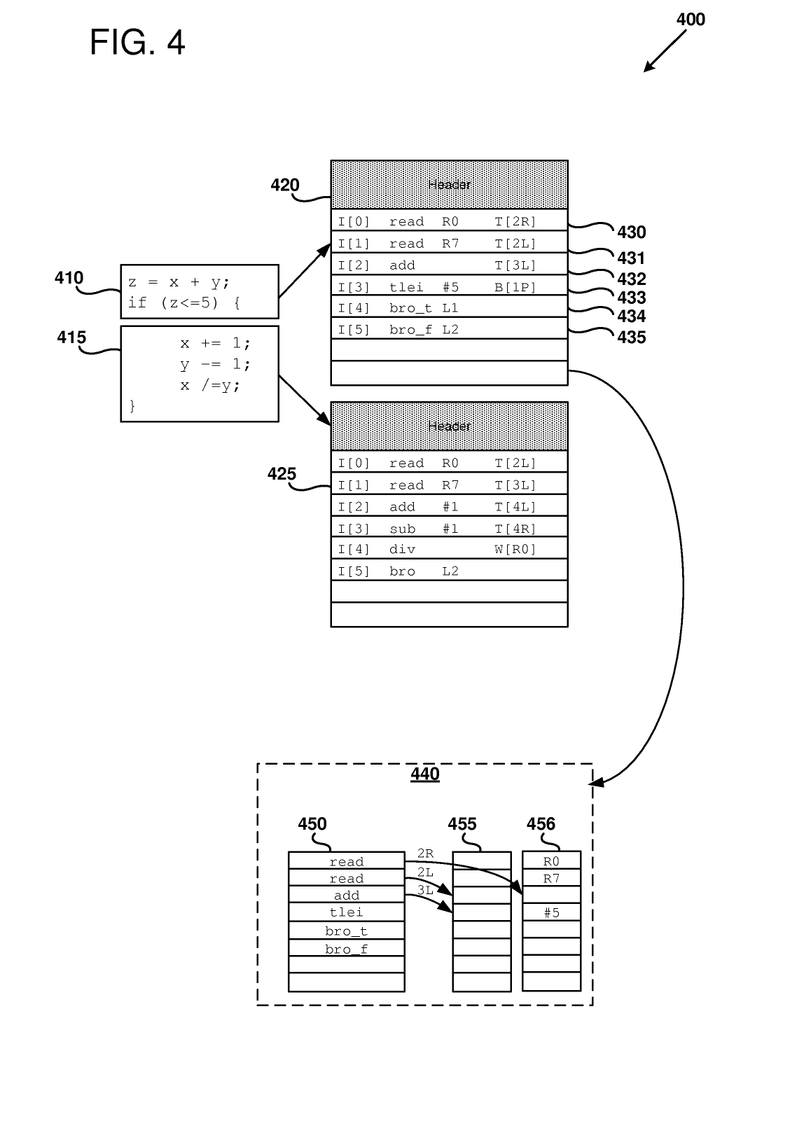

FIG. 4 is a diagram 400 depicting an example of two portions 410 and 415 of C language source code and their respective instruction blocks 420 and 425, illustrating how block-based instructions can explicitly encode their targets. In this example, the first two READ instructions 430 and 431 target the right (T[2R]) and left (T[2L]) operands, respectively, of the ADD instruction 432. In the illustrated ISA, the read instruction is the only instruction that reads from the global register file (e.g., register file 160); however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO_T 434 and BRO_F 435). The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

### VII. Example Block-Based Instruction Formats

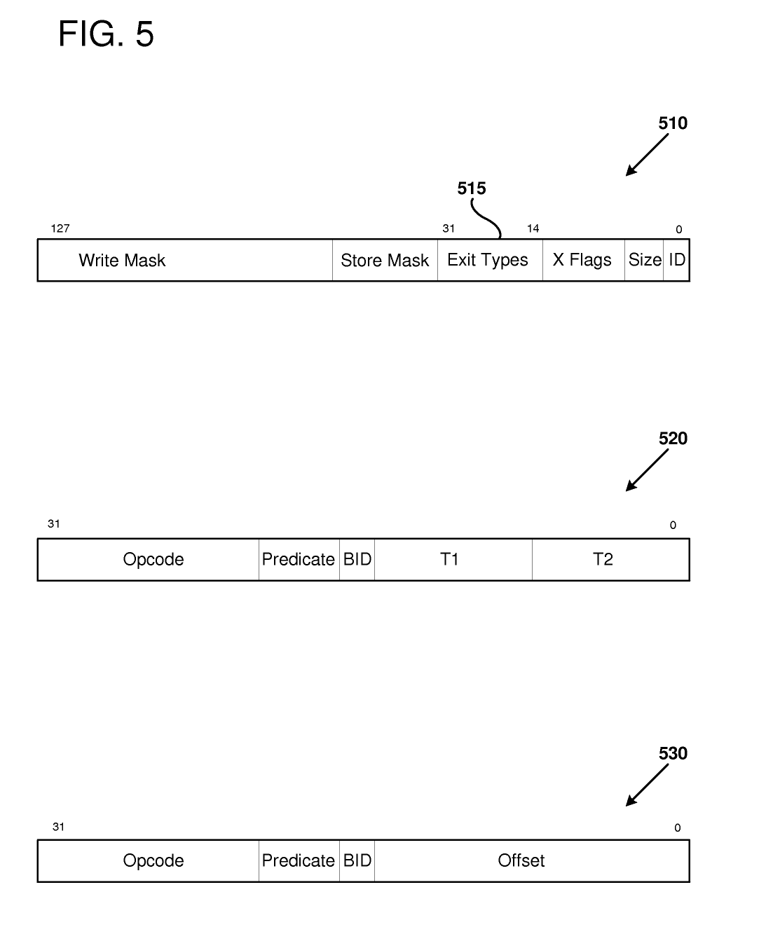

FIG. 5 is a diagram illustrating generalized examples of instruction formats for an instruction header 510, a generic instruction 520, and a branch instruction 530. Each of the instruction headers or instructions is labeled according to the number of bits. For example, the instruction header 510 includes four 32-bit words and is labeled from its least significant bit (lsb) (bit 0) up to its most significant bit (msb) (bit 127). As shown, the instruction header includes a write mask field, a store mask field, a number of exit type fields 515, a number of execution flag fields, an instruction block size field, and an instruction header ID bit (the least significant bit of the instruction header). The exit type fields 515 include data that can be used to indicate the types of control flow instructions encoded within the instruction block. For example, the exit type fields 515 can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields 515 can be used for branch prediction and speculative execution in addition to determining implicit control flow instructions. In some examples, up to six exit types can be encoded in the exit type fields 515, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. Thus, a predicate field specifies, at least in part, a true or false condition that is compared to the predicate result from executing a second instruction that computes a predicate result and which targets the instruction, to determine whether the first instruction should issue. In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. In some examples, the result will be sent to specific left or right operands of slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), a performance metric field 535, and an offset field. The opcode and predicate fields are similar in format and function as described regarding the generic instruction. The offset can be expressed in units of groups of four instructions in some examples, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate value does not match the required predicate, the instruction does not issue. For example, a BRO_F (predicated false) instruction will issue if it is sent a false predicate value.

It should be readily understood that, as used herein, the term “control flow instruction” is not limited to changing program execution to branch to a relative memory location, but also includes jumps to an absolute or symbolic memory location, subroutine calls, and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

### VIII. Examples of Control Flow Instruction Processing

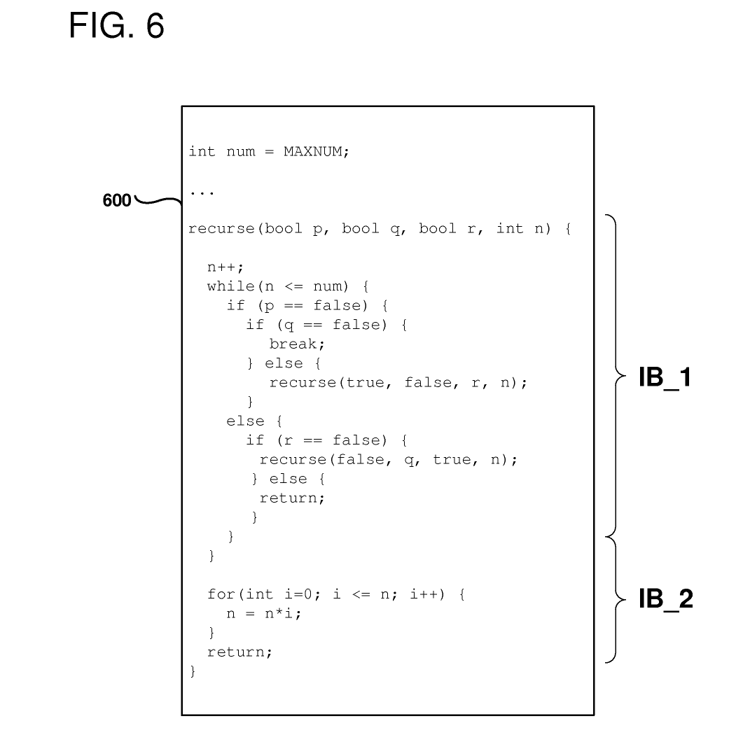

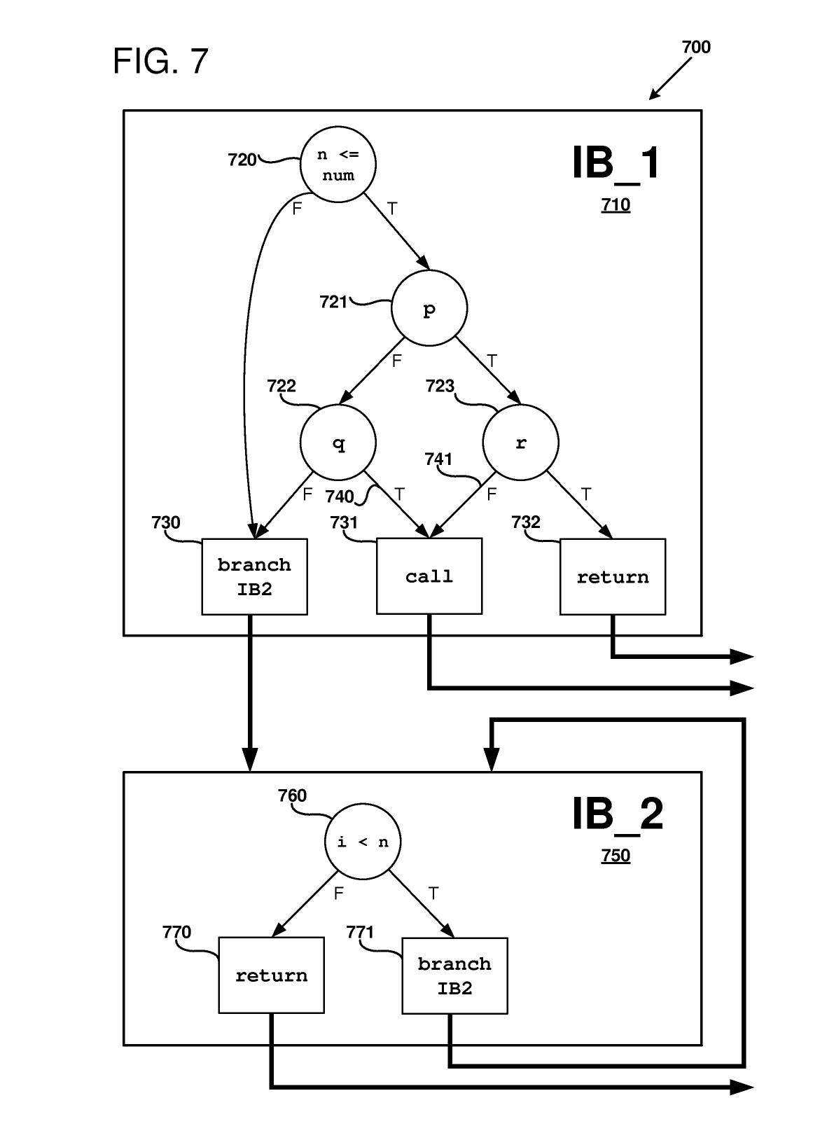

FIG. 6 is an example of pseudocode 600 similar to the C programming language defining a function named “recurse” that can be compiled into instruction blocks for a block-based processor (e.g., an EDGE architecture processor) according to the disclosed technology. The example pseudocode 600 will be used in discussing the example instruction blocks illustrated FIGS. 7-10 and described in further detail below.

As shown, the pseudocode 600 includes a number of source control flow statements, including a while statement, a number of if-then-else statements, a number of return statements, and a for loop statement. When compiled, the source control flow statements will be used to generate a number of machine code control flow instructions, including implicit control flow instructions, as is discussed further below. It should be readily apparent to one of ordinary skill in the relevant art that use of the disclosed methods and apparatus are not limited to the control statements depicted in FIG. 6, but can be applied to other examples of control flow statements, including source control flow statements expressed in any suitable programming language.

In the following examples of FIGS. 7-10, the first portion of the pseudocode 600, including the while loop, will be encoded as a first instruction block (IB_1), while a second portion of the pseudocode, including the for loop statement, will be encoded as a second instruction block (IB_2). The division of the code into two instruction blocks is for illustrative purposes, and, depending on compiler configuration and processor configuration, the same pseudocode 600 could be encoded as one, two, three, or more instruction blocks. As discussed further above, each of the instruction blocks is executed and committed (or aborted in the event of speculative execution) in an atomic fashion. Further, individual instructions need not execute in the sequential order in which the instruction are arranged in memory, but instead can execute once their associated dependencies are ready and the individual instructions have been scheduled for execution.

The examples of FIGS. 7-10 include instruction headers, but in other examples, instruction blocks can also be expressed in forms that do not include instruction headers.

A. Example Predicate DAG

FIG. 7 is a diagram 700 illustrating a predicate directed acyclical graph (DAG) for two instructions blocks (IB_1 and IB_2) generated from the pseudocode 600 of FIG. 6. As shown in the predicate DAG 710 for instruction block 1, there are four predicate nodes 720-723. Each of the predicate nodes 720-723 is associated with a predicate (e.g., n<=num; p==false, etc.) in the pseudo code 600 and will evaluate to a Boolean true or false value, which is indicated by the edges labeled “T”/“F” shown in the predicate DAG 710. Also shown in the predicate DAG 710 are a number of exit points 730, 731, and 732 which represent control flow instructions within the instruction block that are used to transfer control to a next instruction block. Because only one set of predicates can be satisfied for the predicate DAG 710, only one of the exit points 730-732 will be taken for any particular iteration of an instruction block.

As shown, there is an exit point defined for any combination of predicate values calculated during execution of the instruction block. One of the exit points (731), corresponding to a call instruction, can be reached by two different predicate edges 740 and 741. Thus, exit point 731 is reached for an iteration of the first instruction block (IB_1) if and only if (1) n is less than or equal to num (predicate 720) and (2) either p is true and r is false (predicates 721 and 723), or p is false and q is true (predicates 721 and 722). Thus, there are two sets of predicate value combinations that result in the call at exit point 731 being reached and therefore executed.

Each of the exit points can be associated with a control flow instruction within the instruction block corresponding to the predicate DAG 710. As shown, the first exit point 730 corresponds to a branch to the next instruction block, IB_2. The second exit point corresponds to a call control flow instruction (in this case, a call back to instruction block IB_1), and the third exit point 732 corresponds to a return control flow instruction. As will be readily understood to one of ordinary skill in the relevant art, the call and return instructions can be implemented using a variety of techniques, for example, passing in and out parameters in registers and saving the ‘return address’ (e.g. the block containing the continuation of the calling function after the call returns) in a link register, or using a stack frame in order to pass variables and preserve calling instruction block locations when calling and returning from subroutines.

The second instruction block (IB_2) also has a predicate DAG 750. The predicate DAG 750 includes one predicate node 760 having the condition i<n. The predicate DAG 750 has two exit points 770 and 771. The first exit point 770 corresponds to a return control flow statement, while the second exit point 771 is a branch statement back to the same instruction block (IB_2).

Because block-based ISAs according to the present disclosure encode aspects of the predicate DAG within the instruction blocks, these aspects can be used to improve performance, reduce memory consumed by the instructions, and improve branch prediction, depending on a particular implementation of the disclosed technology.

B. First Example Machine Code for Instruction Blocks IB_1 and IB_2

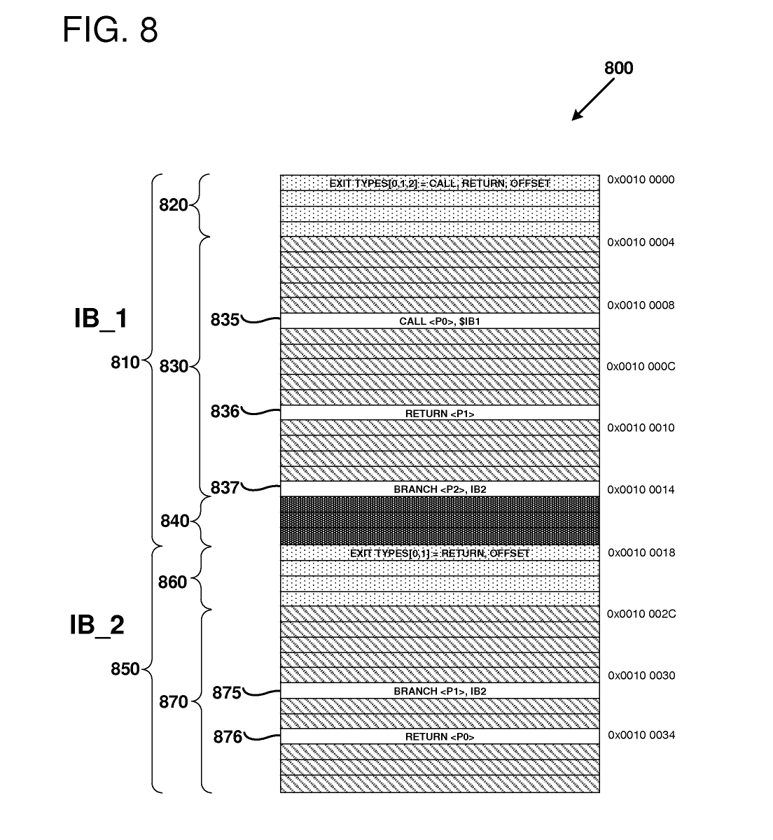

FIG. 8 is a diagram 800 representing machine code for instruction blocks IB_1 and IB_2, generated from the pseudocode 600 discussed above, according to one example of the disclosed technology. Instruction block IB_1 810 includes 24 words of instruction data, including four 32-bit words of an instruction header 820, 17 words of block-based instructions 830, and three unused words 840. The instruction header 820 includes an indication of three exit types corresponding to branches within the instruction block 810, including call, return, and offset, which indicate the type of control flow instruction corresponding to a call instruction 835, a return instruction 836, and a branch to offset instruction 837. Because instruction blocks are sized in four-word chunks in the illustrated ISA, there are three unused words 840. Execution of each of the control flow instructions 835, 836, 837 is predicated on evaluation of a corresponding predicate, for example according the predicate nodes in the DAG 710 of FIG. 7.

Instruction block IB_2 850 includes a four-word instruction header 860 as well as twelve words of instructions 870. The instruction header 860 for instruction block IB_2 indicates two exit types, return and offset. These exit types correspond to a branch instruction 875, and a return instruction 876. It should be understood that individual instructions (e.g., instructions 830 and 870) within any particular instruction block do not necessarily execute in a sequential order according to their memory location ordering, but instead can execute as soon as their associated dependencies, operands, and predicates have been calculated and are available. Thus, execution order of the illustrated instructions 930 and 870 does not rely having a program counter pointing to individual instructions within the instruction block. In other words, the program counter is used to indicate which instruction block is executing, but not whether any individual instruction within an instruction block is executing.

C. Second Example Machine Code for Instruction Blocks IB_1 and IB_2

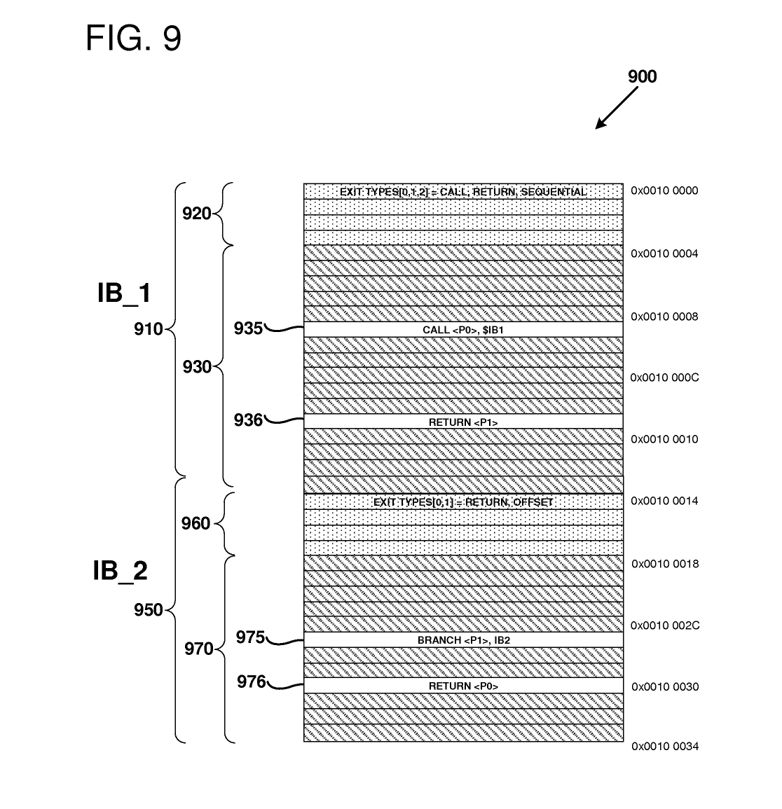

FIG. 9 illustrates an alternative example of machine code for instruction blocks IB_1 and IB_2 for the pseudocode 600 of FIG. 6, as can be used in certain examples of the disclosed technology. As shown, the machine code for instruction block IB_1 910 includes an instruction header 920 and a number of instructions 930, including a call instruction 935 and a return instruction 936. Three exit types: call, return, and sequential, have been encoded in the instruction block header 920, even though there are only two explicitly encoded control flow instructions. Thus, once the processor core instruction window executing instruction block IB_1 has determined that neither the call instruction 935 nor the return instruction 936 will execute, an implicit sequential branch to the next instruction block in memory can be performed. In the illustrated example, a sequential branch is defined as a branch to a program counter address that is equal to the current program counter plus a four word offset corresponding to the size of instruction block IB_1 910. Hence, if neither the call instruction 935, nor the return instruction 936, executes the program counter will be updated to address 0x001000014, the starting point of the machine code for sequentially next instruction block in memory, IB_2 950. Thus, by eliminating encoding of the explicit branch instruction 837 in the encoding of instruction block 910, four words of memory can be saved in the encoding of instruction block IB_1.

Similar to the machine code for the instruction blocks shown in FIG. 8, instruction block IB_2 950 includes an instruction header 960, and a number of instructions 970, including a branch instruction 975 and a return instruction 976.

In some examples of the disclosed technology, control logic circuitry for the instruction window executing instruction block IB_2 910 can evaluate the predicates for the explicit control flow instructions and, based on all of those predicates being calculated, and determined to be not be taken in a particular iteration, the instruction window can determine that an implicit control flow instruction is to be executed. In some examples, a predicate for an implicit control flow instruction can be encoded in other ways, for example by encoding a corresponding predicate in the instruction header 920, or by storing a predicate in a register or in memory.

D. Third Example Machine Code for Instruction Blocks IB_1 and IB_2

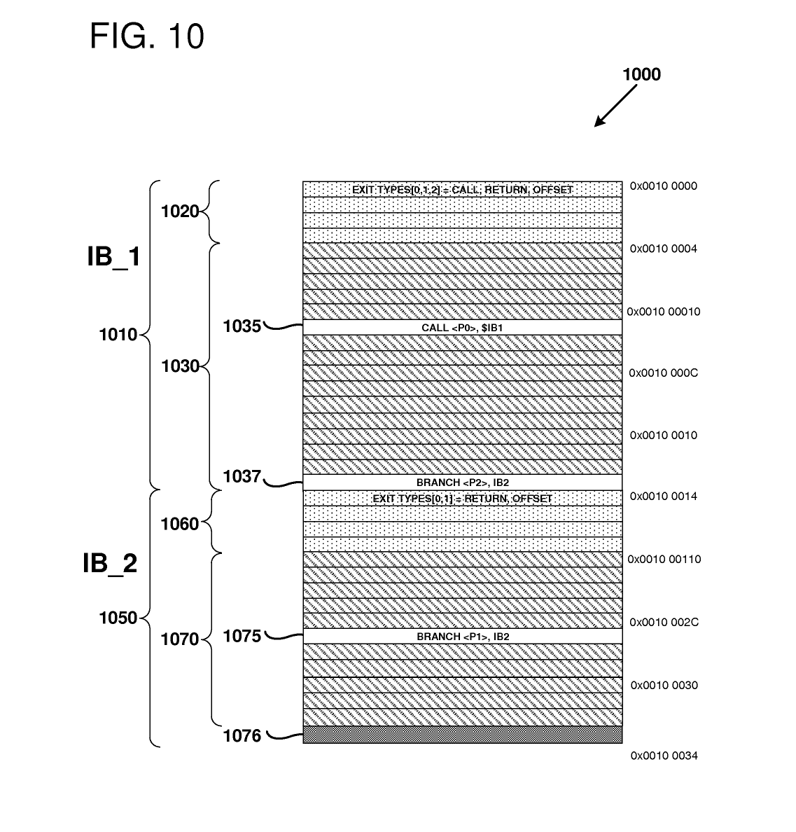

FIG. 10 is a diagram 1000 illustrating an alternative example of instruction block encoding, as can be practiced in certain examples of the disclosed technology. The machine code depicted in FIG. 10 is based on the pseudocode 600 discussed above regarding FIG. 6. As shown in FIG. 10, there is a first instruction block 1010, which includes an instruction header 1020 and a number of instructions 1030, including implicit control flow instructions 1035 and 1037. Also shown in FIG. 10 is a second instruction block 1050 which includes an instruction header 1060 and a number of instruction 1070, including a branch instruction 1075. Also shown is one word of unused data 1076.

In the example of diagram 1000, a block-based processor according to the disclosed technology has been configured such that an eliminated explicit branch instruction is determined to be a return instruction (instead of a sequential branch instruction, as in the example of FIG. 9). Thus, the branch 1037 to instruction block IB_2 is explicitly encoded, while the return instruction is not. In some examples, the encoding of implicit control flow instructions is based, at least in part, on information stored in an instruction block header, for example the exit type information depicted in the diagram 1000. In other examples, a block-based processor can be configured statically, or dynamically at run time, to define the behavior of implied control flow instructions. The implicit control flow instruction information encoded in the headers can also be used by, for example, branch prediction and speculative execution hardware, in order to further improve performance and/or save energy when executing instruction blocks encoded.

Additional analysis can be performed by a processor to determine the appropriate exit point for an instruction block to which control flow is being transferred. For example, in cases where the block has a single successor block, the processor can pass control flow to the next block based on information in the instruction header. This allows for the removal of an unpredicated branch instruction to the next instruction block.

In other examples, for example, a loop block that can either branch to the same instruction block, or branch to the following instruction block, predicated instruction reachability analysis can be applied by the processor to determine the next instruction block. In particular, when an instruction block commits and its next branch occurs, the processor first determines that all the writes in the write mask, all the stores in the store mask, and execution of one control flow instruction has occurred. Thus, generally speaking the processor core continues to issuing instructions in dataflow order, until there are no more to issue.

In some examples, additional analysis by the processor is used to determine which exit point of an instruction block will be taken. For example, an instruction block may include multiple predicates, some of which may directly or transitively predicate execution of a call or return. In such examples, predicate evaluation is itself predicated on a precedent predicate. In such cases, some predicates will not be evaluated for that instance of an instruction block. In some examples, an instruction may be a target for predication of any number of other instructions in the block. In some examples, conditional branch instructions are not necessarily directly predicated. For example, a conditional indirect branch may not be predicated although the evaluation of its branch target address operand may be.

These issues can be addressed in a number of suitable fashions. For example, if an executing block has no issuable instructions and is awaiting no responses on issued instructions (e.g., due to load responses or long latency floating point unit (FPU) responses, or because the block's dataflow execution is over, and no branch has been executed) then the processor can determine if the instruction block is associated with a default branch target, e.g. next sequential block), and then transfer control to the target location (e.g., the next sequential block).

In some examples, predicate target field encoding is extended to enable targeting of exit fields in the instruction block branch header. In some examples, the instruction block header defines a predicate target field encoding value that designates default next target locations (e.g., “BRO.T/F 0” (e.g., branch to self, as in a loop)) “BRO.T/F next sequential block.”

In some examples of the disclosed technology, determination of an exit point that will be taken can be determined as follows. When an instruction block is fetched, a control flow graph is constructed by the control logic circuitry, and at least a portion of the control flow instructions are analyzed and dynamically assigned to three categories: taken branch (the branch will be Taken, Not-Taken branch (the branch cannot be taken for this execution instance of the instruction block, or Don't Know branch (further execution of the block to be performed before determining if dataflow and predication will cause the branch to issue). The control flow instructions will typically be assigned as Don't Know branches when the control flow graph is initially constructed, and then as predicates are calculated as execution of the instruction block proceeds, individual branches can be reassigned to the taken or not-taken branch categories.

As instruction issue and predicates are evaluated, instructions targeted by a predicate which evaluates to the wrong value, and instructions they target, are discovered to be “Not Predicated” in this particular execution instance of the block. “Not Predicated” branch instructions may be added to the Not Taken Branches set. Once execution of a block causes issuance of enough instructions to grow the size of the Not Taken set to N−1 items, the remaining branch declared in the block header exit types is determined to occur.

### IX. Example Method of Transferring Control Flow

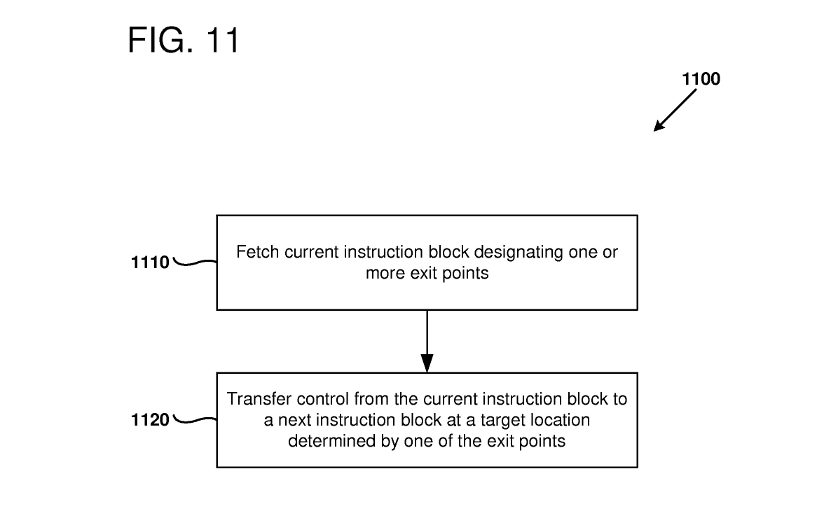

FIG. 11 is a flowchart 1100 outlining an example method of transferring control flow between instruction blocks, as can be performed using a block-based instruction set architecture processor according to the disclosed technology. A block-based ISA processor can be coupled to memory and include one or more processor cores that are configured to fetch instruction blocks from the memory and execute a current one of the instruction blocks. The current instruction block is encoded to designate one or more exit points to determine a target location of a next instruction block to execute after the current instruction block is executed. For example, the machine code discussed above regarding FIGS. 7-10 can be used to encode exit points, although the disclosed technology is not limited to those illustrative examples.

At process block 1110, a current instruction block designating one or more exit points that determine a target location of a next instruction block is fetched and decoded. For example, a processor-level or core-level scheduler can be used to map, fetch, and decode the instruction block to an instruction window of a processor core. Once the current instruction block has been fetched and decoded, the method proceeds to process block 1120.

At process block 1120, control of the block-based processor is transferred from a currently executing instruction block to a next instruction block using, for example, control logic circuitry within a block-based processor core. In some examples, information designating exit points in an instruction block header is utilized by the control logic circuitry to determine a next instruction block and its corresponding target location in memory. In some examples, the method includes evaluating predicates for the instruction block and, based on the evaluated predicates and the exit point information encoded in the instruction header, the control logic circuitry determines that an implicit control flow instruction is to be executed. In some examples, the implicit control flow instruction is a sequential branch instruction, in other words, control flow for the currently executing thread will transfer to the next instruction block in memory (above or below the currently executing instruction block in memory).

In some examples of the disclosed technology, the current instruction block includes at least one fewer control flow instructions than the number of exit points for the current instruction block. Thus, the instruction block can be encoded with fewer explicit control flow instructions. In some examples, the control logic circuitry is configured to transfer control of the processor thread to a target location that is not indicated by any control flow instruction within the currently executing instruction block. In some examples, the apparatus further includes a core scheduler for mapping instruction blocks to respective processor cores. The core scheduler can be configured to speculatively execute control flow instructions based at least in part on the exit type information encoded in the instruction header.

While sequential branch instructions (e.g., branches to a contiguous instruction block in memory) are one example of implicit control flow instructions that can be executed, the method is not so limited, and can be used with any suitable control flow instruction including: branch instructions, jump instructions, procedure calls, and/or procedure returns. The control flow instructions either can be conditional, based on a predicate, or unconditional, for one or more of the respective control flow instructions. The control flow instructions can indicate their corresponding target location as a relative address, an absolute address, or as an address reference stored in a register or in memory. In some examples, the control logic circuitry uses a search tree to evaluate dependencies of the explicit control flow instructions to determine when an implicit control flow instruction is to be executed. Because at least a portion of the instruction block dependencies can be encoded within the instruction block, processor resources can avoid at least some of the time and energy used to determine such dependencies in traditional CPU architectures.

### X. Example Method of Implicit Encoding of Control Flow Instructions

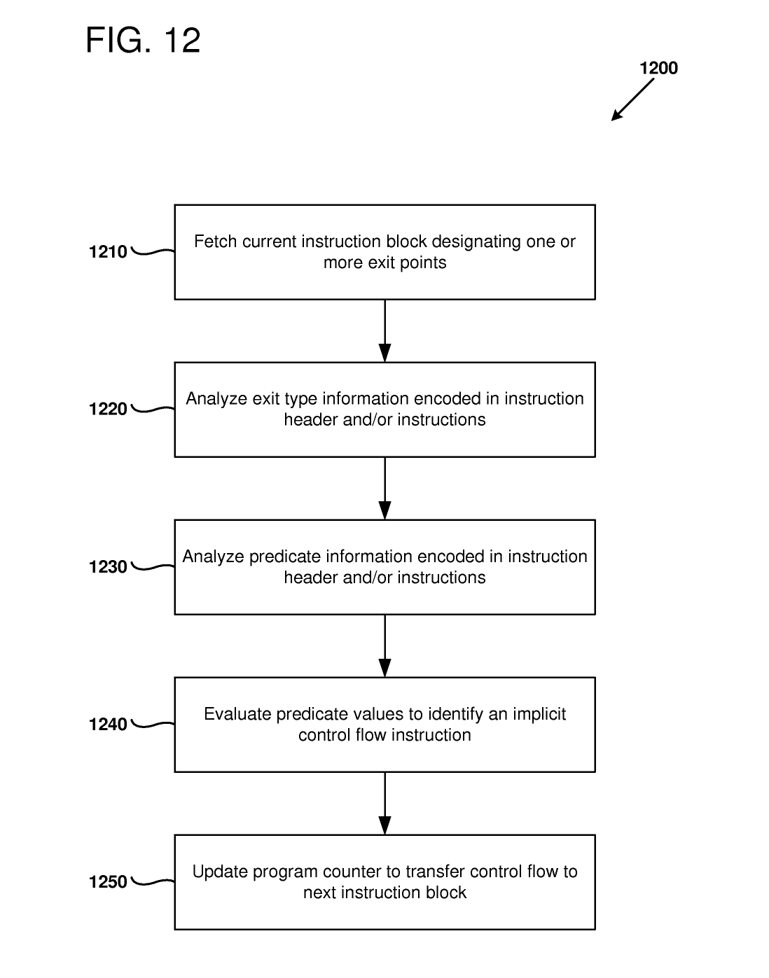

FIG. 12 is a flowchart 1200 outlining an example method of transferring control flow from a current instruction block to a next instruction block, as can be performed using a block-based instruction set architecture processor according to the disclosed technology. For example, the block-based processor 100 of FIG. 1 can implement the example method outlined by the flowchart 1200. The machine code discussed above regarding FIGS. 7-10 can be used as the instruction blocks for this example method, although the disclosed technology is not limited to those illustrative examples of machine code instruction blocks.

At process block 1210, the method fetches a current instruction block that includes encodings designated one or more exit points for the current instruction block. For example a processor-level control unit 160 or a processor core-level control unit 205 can be used to map, fetch, and decode the current instruction block. The memory location of the current instruction block is designated by a program counter, which indicates the address in memory where the current instruction block is located. The instruction block is fetched and decoded onto one or more instruction windows of a processor core, and this fetching and decoding can continue until the entire instruction block has been fetched and decoded. Once the current instruction block has been fetched, the method proceeds to process block 1220.

At process block 1220, exit type information encoded in an instruction block, including within an instruction block header and/or block-based instructions of the instruction block, are analyzed. This information can be encoded in a number of ways, an example of which is discussed above regarding FIGS. 7-10. For example, the exit type information can be encoded within the header as indicating different control flow instruction types that are encoded within the instructions of the instruction block. Further, control flow instructions encoded within the instruction block also can be used to determine exit types by, for example, analyzing opcodes for the control flow instructions. In some examples, an instruction block has fewer control flow instructions encoded than the number of exit points. A block-based processor can use the exit type information in view of the control flow instructions to determine implicit control flow instructions, for example, a sequential branch to the next instruction block in memory. The next instruction block in memory can be a designated location near, (either higher or lower in memory) the currently executing instruction block in memory. Once the exit type information has been analyzed, the method proceeds to process block 1230.

At process block 1230, predicate information encoded in the instruction header and/or instructions of the instruction block is analyzed. For example, the predicate information can be analyzed to determine which values associated with the predicates must be evaluated, and to which values, in order to determine which one of the exit points of the instruction block will be taken for the current iteration of the instruction block. The predicate information analyzed at process block 1230 can be cached in a memory coupled to a processor core or otherwise temporarily stored until the values of the associated predicates are known. After analyzing the predicate information, the method proceeds to process block 1240.

At process block 1240, predicate values associated with the analyzed predicate information from process block 1230 are evaluated in order to identify a control flow instruction associated with the exit point. Thus, if the predicate values do not correspond to any of the explicit control flow instructions of the instruction block, the method can determine that an implicit control flow instruction is to be executed. The implicit control flow instruction itself can be determined in a number of ways. For example, if one of the exit types encoded in the instruction header does not correspond to an explicitly encoded instruction, then the implicit control flow instruction corresponds to the remaining exit type encoded in the header. In other examples, the implicit control flow instruction can be determined by reading a value from a table, by a particular configuration of the processor, determined by data created by the programmer or a user executing an application, or encoded within a header for the overall sequence of instruction blocks. Once an implicit control flow instruction has been identified, the method proceeds to process block 1250.

At process block 1250, a program counter of the block-based processor is updated in order to transfer control flow of a sequence of instruction blocks to the next instruction block. The next instruction block was identified by the implicit control flow instruction identified at process block 1240. In some examples, a register file of a block-based processor includes a designated one or more program counters that can correspond to each of a number of instruction block execution threads. In other examples, program counter(s) are stored as values in a portion of the memory address space of the block-based processor. In other examples, additional techniques for implementing a program counter can be used, as will be readily understood to one of ordinary skill in the relevant art. After the program counter has been updated, the instruction block designated as the next block can be mapped, fetched, decoded, and executed. In some examples, the program counter may be updated, and execution begins speculatively, while in other examples, the processor controller waits until the current instruction block has committed before updating the program counter.

In some examples of the disclosed technology, the predicate information is analyzed at least in part by constructing a DAG that includes information about control flow of instruction blocks, corresponding predicates, and values that are evaluated to determine predicates. In some examples, this DAG is analyzed and constructed statically by a compiler as part of emitting machine code for instruction blocks. In other examples, at least a portion of the DAG is generated dynamically when executing a sequence of instruction blocks.

Accordingly, performance of the illustrated and similar methods allow for improvements in code size, reduced latency in initiating execution of a next instruction block, and avoidance of branch prediction and/or speculative execution, depending on the particular implementation, by encoding at least one of the exit points for a particular instruction block in an implicit fashion and in some examples, using exit type or other information encoded within an instruction block header.

### XI. Example Method of Emitting Encoded Instruction Blocks

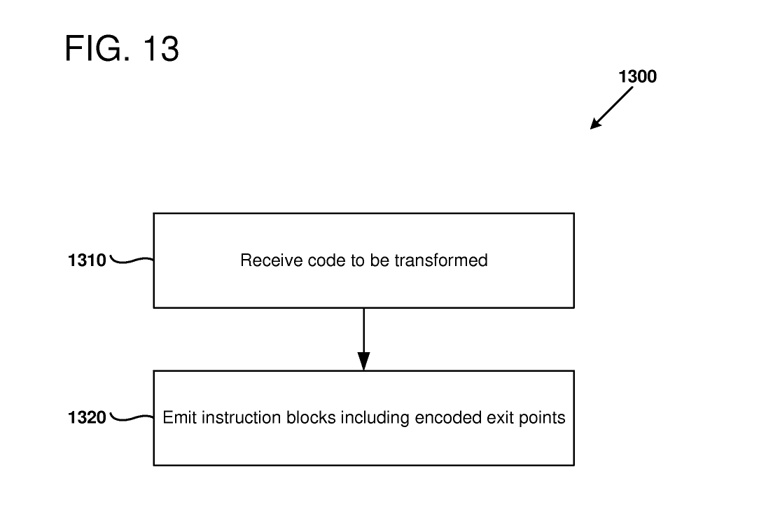

FIG. 13 is a flowchart 1300 illustrating an example method of emitting instruction blocks according to the disclosed technology. The method of FIG. 13 can be performed using, for example, by executing computer-readable instructions with a general-purpose processor or a block-based ISA processor.

At process block 1310, a compiler program operating on a suitable processor receives code to be transformed to machine code. For example, the code can be human-readable source code, such as the pseudocode 600 of FIG. 6, or intermediate language code produced by a compiler or an assembler. After receiving the code to be compiled, the method proceeds to process block 1320.

At process block 1320, machine code (object code) is emitted for one or more instruction blocks for execution by a block-based processor. The emitted instruction blocks include one or more exit points encoded within the instruction blocks according to a block-based processor ISA. In some examples, at least one of the emitted instruction blocks includes one fewer branch instruction than the number of exit points for the respective instruction block. For example, the emitted instruction blocks can include an instruction editor with exit type codes to indicate the presence of an implied control flow instruction. In some examples, the method includes evaluating a predicate DAG for the received code in order to determine whether there are shared exit points within the predicate DAG and hence, candidates for eliminating explicit control flow instructions. In some examples, the method includes identifying certain types of control flow instructions, for example, a sequential branch instruction to a next instruction block that can be encoded as implicit control flow instructions.

The instructions blocks emitted at process block 1320 can be stored in one or more computer-readable storage media or devices for later execution by a block-based processor. In some examples, at least one of the control flow instructions has a target location that is not designated by any of the branch instructions within a particular instruction block. In some examples, branch exit types encoded within an instruction header for at least one of the instruction blocks is encoded to indicate an implicit control flow instruction. For example, a branch exit type can be encoded within bits 31-14 of an instruction header using an appropriate code, for example a three-bit code “010.” In some examples, the method includes analyzing a predicate graph for at least one of the instruction blocks to determine duplicate exit points and eliminate at least one of the duplicate exit points in the emitted code. Therefore, the emitted code includes at least one fewer branch instruction than the number of exit points for the instruction block. Any of the instruction blocks of FIGS. 7-10 can be emitted using the method outlined in the flow chart 1300.

### XII. Example Computing Environment

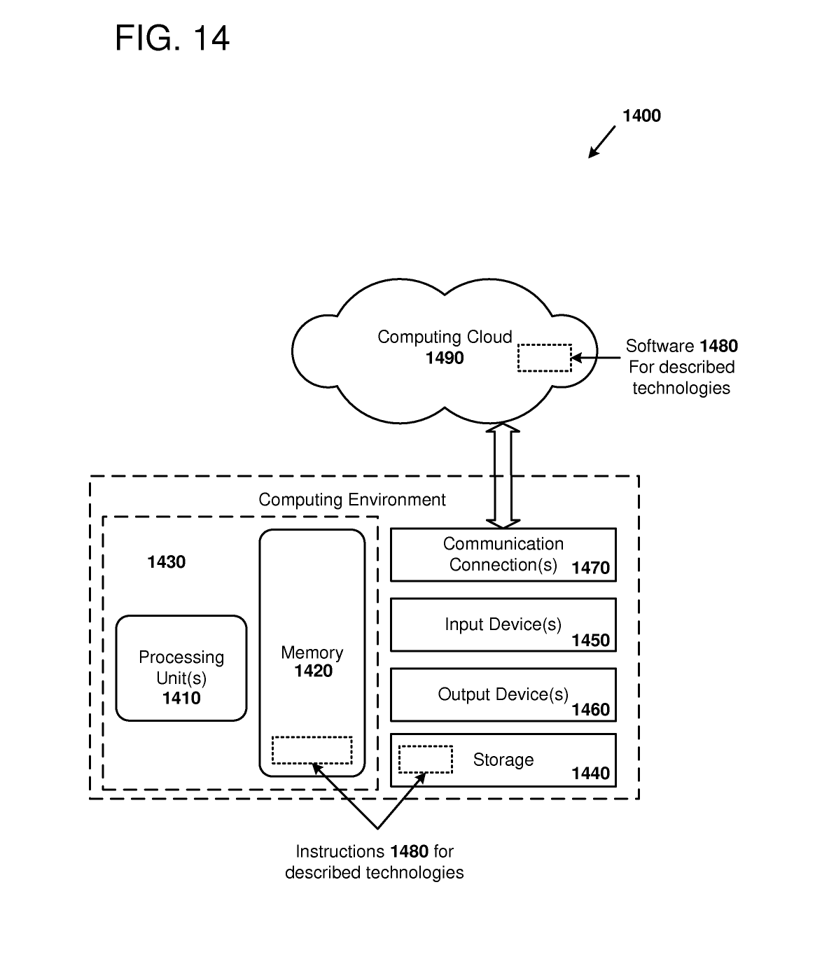

FIG. 14 illustrates a generalized example of a suitable computing environment 1400 in which described embodiments, techniques, and technologies, including execution in a block-based processor, can be implemented. For example, the computing environment 1400 can implement execution of instruction blocks having disclosed exit types by processor cores or emitting instruction blocks having disclosed exit types according to any of the schemes disclosed herein.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input devices 1450, one or more output devices 1460, and one or more communication connections 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment 1430, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XIII. Additional Examples of the Disclosed Technology

Additional examples of the disclosed subject matter are discussed herein in accordance with the examples discussed above.

In one example of the disclosed technology, an apparatus including a block-based instruction set architecture (ISA) processor. The apparatus further includes memory, one or more processer cores configured to fetch a plurality of instruction blocks from the memory and execute a current instruction block of the plurality of instruction blocks, the current instruction block having a number of one or more exit points, and control logic circuitry configured to transfer control of the processor from the current instruction block to a next instruction block at a target location determined by one of the current instruction block's exit points.

In some examples of the apparatus, the current instruction block includes at least one fewer control flow instructions than the number of exit points for the current instruction block. In some examples, the control logic circuitry is configured to transfer control of the processor to the next instruction block at the target location, where the target location is not encoded by a control flow instruction in the current instruction block. In some examples, the control logic circuitry is configured to determine that the target location is at an address immediately following the current instruction block. In some examples, the control logic circuitry is configured to determine the target location of the next instruction block based at least in part on exit type information encoded in an instruction header for the current instruction block. In some examples, the apparatus further includes a core scheduler configured to map the instruction blocks for execution on respective ones of the processor cores, the core scheduler being configured to speculatively execute at least one control flow instruction based at least in part on the exit type information.

In some examples of the apparatus, the current instruction block includes at least one fewer control flow instructions than the number of exit points for the current instruction block, the at least one fewer control flow instructions include at least one or more of the following: branch, jump, procedure call, or procedure return. Each of the at least one fewer control flow instructions are either conditionally or unconditionally based on a predicate for at least one of the control flow instructions, and each of the at least one fewer control flow instructions indicates a target location as either a relative or absolute address.

In some examples of the apparatus, the control logic circuitry is configured to transfer control of the processor by performing at least one or more of the following acts: storing a value indicating a memory location of the next instruction block in a program counter register, signaling at least one of the processor cores to fetch an instruction block from a target location stored in a program counter register, or writing a target location address to a memory location and signaling at least one of the processor cores to fetch an instruction block from a target location designated by the memory location. In some examples, the instructions in the instruction blocks are to be executed by respective ones of the processor cores in an order according to availability of dependencies for each of the respective instructions.

In another example of the disclosed technology, an apparatus includes a block-based processor, and the processor includes one or more processer cores configured to fetch instruction blocks from a memory and execute at least one of the instruction blocks, each of the instruction blocks being encoded to have one or more exit points to determine a target location of a next instruction block, control logic circuitry configured to transfer control of the processor to the determined target location in response to performance of operations, the operations comprising an operation to evaluate one or more predicates for instructions encoded within a first one of the instruction blocks, based on the operation to evaluate, an operation to transfer control of the processor to a second instruction block at the target location, where the target location is not specified by a control flow instruction in the first instruction block.

In some examples of the apparatus, the evaluating is based at least in part on an exit type code encoded in an instruction header of the first one of the instruction blocks. In some examples, the target location for the second instruction block is located at a memory location immediately before or after the first instruction block in memory. In some examples, the target location for the second instruction block is determined as if the first instruction block executed a call, return, or branch instruction. In some examples, the apparatus includes a core scheduler for mapping the instruction blocks for execution on respective ones of the processor cores, the core scheduler being configured to avoid branch prediction based at least in part on exit type information encoded in a header of at least one of the instruction blocks.

In another example of the disclosed technology, one or more computer-readable storage media storing computer-readable instructions that when executed by a computer cause the computer to perform a method, the computer-readable instructions including instructions to emit one or more instruction blocks for execution by a block-based processor, at least one of the instruction blocks including one or more exit points encoded within the instruction block, the at least one of the instruction blocks including one fewer branch instructions than the number of exit points.

In some examples of the computer-readable storage media, the instructions further includes instructions to store the emitted instruction blocks in one or more computer-readable storage media or devices. In some examples, the instructions further include instructions to encode an instruction header in the at least one of the instruction blocks, the instruction header including one or more branch exit types that indicate at least one target location that is not designated by any of the control flow instructions encoded in the instruction block.

In some examples, the instructions further include instructions to encode an instruction header in the at least one of the instruction blocks, the instruction header including one or more branch exit types that indicate that a next instruction block contiguous to the at least one instruction blocks is to be a target location for a control flow instruction, the target location not being designated by any of the control flow instructions encoded in the instruction block.

In some examples, the instructions further include instructions to encode an instruction header in the at least one of the instruction blocks, the instruction header including one or more branch exit types that indicate that a next instruction block contiguous to the at least one instruction blocks is to be a target location for a control flow instruction, the branch exit types being encoded within bits 31 through 14 of the instruction header, and at least one of the branch exit type being encoded by the three-bit pattern 010.

In some examples, the instructions further include instructions to analyze a predicate graph for the at least one of the instruction blocks to determine one or more duplicate exit points and eliminating at least one of the duplicate exit points, thereby emitting the at least one of the instruction blocks including at least one fewer branch instruction than the number of exit points for the at least one of the instruction blocks.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus comprising a block-based instruction set architecture (ISA) processor, the apparatus comprising:
memory;
one or more processer cores configured to fetch a plurality of instruction blocks from the memory and execute a current instruction block of the plurality of instruction blocks, the current instruction block having a number of one or more exit points; and
control logic circuitry configured to transfer control of the processor from the current instruction block to a next instruction block at a target location determined by one of the current instruction block's exit points.

2. The apparatus of claim 1, wherein the current instruction block includes at least one fewer control flow instructions than the number of exit points for the current instruction block.

3. The apparatus of claim 1, wherein the control logic circuitry is configured to transfer control of the processor to the next instruction block at the target location, wherein the target location is not encoded by a control flow instruction in the current instruction block.

4. The apparatus of claim 3, wherein the control logic circuitry is configured to determine that the target location is at an address immediately following the current instruction block.

5. The apparatus of claim 1, wherein the control logic circuitry is configured to determine the target location of the next instruction block based at least in part on exit type information encoded in an instruction header for the current instruction block.

6. The apparatus of claim 5, further comprising a core scheduler configured to map the instruction blocks for execution on respective ones of the processor cores, the core scheduler being configured to speculatively execute at least one control flow instruction based at least in part on the exit type information.

7. The apparatus of claim 1, wherein:
the current instruction block includes at least one fewer control flow instructions than the number of exit points for the current instruction block, the at least one fewer control flow instructions include at least one or more of the following: branch, jump, procedure call, or procedure return;
each of the at least one fewer control flow instructions are either conditionally or unconditionally based on a predicate for at least one of the control flow instructions; and
each of the at least one fewer control flow instructions indicates a target location as either a relative or absolute address.

8. The apparatus of claim 1, wherein the control logic circuitry is configured to transfer control of the processor by performing at least one or more of the following acts:
storing a value indicating a memory location of the next instruction block in a program counter register;
signaling at least one of the processor cores to fetch an instruction block from a target location stored in a program counter register; or
writing a target location address to a memory location and signaling at least one of the processor cores to fetch an instruction block from a target location designated by the memory location.

9. The apparatus of claim 1, wherein:
the instructions in the instruction blocks are to be executed by respective ones of the processor cores in an order according to availability of dependencies for each of the respective instructions.

10. An apparatus comprising a block-based processor, the processor comprising:
one or more processer cores configured to fetch instruction blocks from a memory and execute at least one of the instruction blocks, each of the instruction blocks being encoded to have one or more exit points to determine a target location of a next instruction block; and
control logic circuitry configured to transfer control of the processor to the determined target location in response to performance of operations, the operations comprising:
an operation to evaluate one or more predicates for instructions encoded within a first one of the instruction blocks, and
based on the operation to evaluate, an operation to transfer control of the processor to a second instruction block at the target location, wherein the target location is not specified by a control flow instruction in the first instruction block.

11. The apparatus of claim 10, wherein the evaluating is based at least in part on an exit type code encoded in an instruction header of the first one of the instruction blocks.

12. The apparatus of claim 10, wherein the target location for the second instruction block is located at a memory location immediately before or after the first instruction block in memory.

13. The apparatus of claim 10, wherein the target location for the second instruction block is determined as if the first instruction block executed a call, return, or branch instruction.

14. The apparatus of claim 10, further comprising a core scheduler for mapping the instruction blocks for execution on respective ones of the processor cores, the core scheduler being configured to avoid branch prediction based at least in part on exit type information encoded in a header of at least one of the instruction blocks.

15. One or more computer-readable storage media storing computer-readable instructions that when executed by a computer cause the computer to perform a method, the computer-readable instructions comprising:
instructions to emit one or more instruction blocks for execution by a block-based processor, at least one of the instruction blocks including one or more exit points encoded within the instruction block, the at least one of the instruction blocks including one fewer branch instructions than the number of exit points.

16. The computer-readable storage media of claim 15, wherein the instructions further comprise instructions to store the emitted instruction blocks in one or more computer-readable storage media or devices.

17. The computer-readable storage media of claim 15, wherein the instructions further comprise instructions to encode an instruction header in the at least one of the instruction blocks, the instruction header including one or more branch exit types that indicate at least one target location that is not designated by any of the control flow instructions encoded in the instruction block.

18. The computer-readable storage media of claim 15, wherein the instructions further comprise instructions to encode an instruction header in the at least one of the instruction blocks, the instruction header including one or more branch exit types that indicate that a next instruction block contiguous to the at least one instruction blocks is to be a target location for a control flow instruction, the target location not being designated by any of the control flow instructions encoded in the instruction block.

19. The computer-readable storage media of claim 15, wherein the instructions further comprise instructions to encode an instruction header in the at least one of the instruction blocks, the instruction header including one or more branch exit types that indicate that a next instruction block contiguous to the at least one instruction blocks is to be a target location for a control flow instruction, the branch exit types being encoded within bits 31 through 14 of the instruction header, and at least one of the branch exit type being encoded by the three-bit pattern 010.

20. The computer-readable storage media of claim 15, wherein the instructions further comprise instructions to analyze a predicate graph for the at least one of the instruction blocks to determine one or more duplicate exit points and eliminating at least one of the duplicate exit points, thereby emitting the at least one of the instruction blocks including at least one fewer branch instruction than the number of exit points for the at least one of the instruction blocks.
